(19) United States
(12) Patent Application Publication
(10) Pub. No.: US 2026/0194096 A1
(43) Pub. Date: Jul. 9, 2026

(54) Clamping System

(71) Applicant: 1000517608 ONTARIO LTD., Belleville (CA)

(72) Inventors: Ian Kirby, Belleville (CA); Timothy Moorcroft, Ashton (CA)

(21) Appl. No.: 19/011,815

(22) Filed: Jan. 7, 2025

(51) Int. Cl. F16B 9/02; E04H 12/22; F16B 2/06; F16B 5/06

(52) U.S. Cl. CPC F16B 9/02; E04H 12/22; F16B 2/065; F16B 5/0607

(57) ABSTRACT

An inverted T-shaped member has a lower clamping end and an upper end that can be coupled to an upstanding pole. The pole rests on a base and relatively turning a complementary threaded portion of the pole and base tightens or loosens the lower clamping end surface and the base against deck boards. The system provides a way in which to clamp an upstanding member to a deck for holding cups or glasses or other items that need support.

### FIELD

This disclosure relates generally to multi-purpose stands, and in particular to a portable stand with various attachments that can be coupled to the stand as required.

### DESCRIPTION OF RELATED ART

Portable stands that are easily moveable have been an economical solution for different indoor and outdoor occasions such as performances, meetings, conferences, and social events. Stands in varying sizes and shapes are available in aluminum, plastic or other materials. U.S. Pat. No. 20050040297 to Saraf on Feb. 24, 2005 discloses a multi-purpose ground stand used to securely affix an umbrella or any like device. The device is fixed into any malleable surface such as sand, grass, gravel or dirt and the device is intended to accommodate any size or shape of commercially available beach or sun umbrellas. These stands have been intended for use with only umbrellas and are limited to outdoor applications where they must be pushed into the ground to achieve stability. This approach does not allow for use of the product on hard surfaces.

U.S. Pat. No. 5,483,901 to Tisbo on Jan. 16, 1996 relates to a tray table of modular construction with readily replaceable and interchangeable plastic molded components that can be assembled by hand. A pair of first legs and second legs is connected to the underside of the tray. However, such a tray table is low, large and cumbersome and may not be suitable on decking with gaps between boards.

U.S. Pat. No. 6,040,267 entitled Clamping Holder for a Lamp or flowerpot in the name of Mendelsohn et al. appears to perform its intended function of clamping a flowerpot to a structure, and although this clamping device allows the holder to be clamped and affixed to a railing or other structure it does not allow affixing to a surface such as a deck unless it is affixed to a side thereof.

Clamps of various sizes and shapes are known. However, none of these appear to be useful for clamping between boards or planks with a very small gap therebetween, in a convenient way.

Providing a support for drinks and the like on a deck often requires providing a small table or stool to place items on. Plastic drink holders are commercially available which clamp onto a railing of a deck; however, these confine the location of the cup to the railing and do not allow or provide a way in which drinks may be supported anywhere on a deck platform at a comfortable or adjustable height. Many of the prior art designs provide a certain basic amount of stability, and free-standing holders can be accidently knocked over.

What is desired is to have a holder for an item such as a cup, bowl, container or other item, that is firmly supported by slatted plank surface such as a deck, and can stand upward at an adjustable height without the necessity of permanently fixing the holder; furthermore, what is needed is a holder that can be quickly securely be installed and quickly removed or moved to a different location with ease and securely clamped.

### SUMMARY

In accordance with an aspect of the disclosure there is provided, an inverted T-shaped member having an elongate clamping portion about a bottom end thereof, the elongate clamping portion sized in a first dimension to fit through a slot between two adjacent boards, the slot having a width W, the elongate clamping portion having a length L larger than the width W, said elongate clamping portion for engaging second surfaces of two of the boards when oriented at a non-zero angle to the slot between the two adjacent boards, wherein the inverted T-shaped member has an upper end portion;
a second clamping member having a greater length and width than W, said second clamping member for engaging upper surfaces of the two adjacent boards; and,
a pole for releasably coupling to the second clamping member, the pole having an opening to accommodate the upper end portion of the T-shaped member, wherein, the pole and the upper end portion of the inverted T-shaped member include means for releasably locking together, and whereby turning one of the pole and the second clamping means relative to the first clamping member releasably couples the elongate clamping portion and the second clamping member to the two adjacent boards.

In accordance with an aspect of the disclosure there is provided, a clamping system for removably securing a pole to a plurality of boards, each board having a first surface and an opposing second surface, wherein adjacent boards have a longitudinal slot therebetween, comprising:
a first member having an elongate clamping portion, the elongate clamping portion sized in a first dimension to fit through a slot between two adjacent boards, the slot having a width W, the elongate clamping portion having a length L larger than the width W, said elongate clamping portion for engaging second surfaces of two of the boards when oriented at a non-zero angle to the slot between the two adjacent boards, wherein the first member has a portion having a screw-like portion extending from the elongate clamping portion; and,
a second clamping member having a greater length and width than W, said second clamping member for engaging upper surfaces of the two adjacent boards, wherein the second clamping member includes a pole having a complementary opening to accommodate the screw-like portion, wherein in operation, the pole and the screw-like portion when screwed together, releasably couple the elongate clamping portion and the second clamping member to the two adjacent boards.

In accordance with the disclosure, a clamping system is provided for removably securing a pole to a deck having an upper surface and a lower surface, the deck having a longitudinal gap between adjacent deck boards, comprising:
an inverted T-shaped member having a bottom portion and a top portion;
wherein the bottom portion of the inverted T-shaped member is sized to be inserted through a longitudinal slot between adjacent deck boards,
wherein the top portion of the inverted T-shaped member includes a screw-like upper end and is of a length such that the top portion extends above the upper surface of the deck when the bottom portion is below the lower surface of the deck;
a pole, having a cross section larger than the slot;
wherein the screw-like upper end of the top portion of the inverted T-shaped member is configured to engage and end of the pole and screw into the pole when the pole is positioned over the upper surface of the deck, thereby pulling the pole and the and the inverted T-shaped member together with the adjacent deck boards between.

In another aspect of the disclosure a kit for securing pole is provided, comprising:
a) an inverted T-shaped member having a base and a stem, the base forming an elongate clamping portion sized in a first dimension to fit through a slot between two adjacent boards, the slot having a width of W wherein W<=⅓″ inch, the elongate clamping portion having a length greater than 3 W, the stem of the T-shaped member having a screw-like end portion;
b) a second clamping member having a greater length and width than 3 W;
c) a pole having an end for coupling to the second clamping member, wherein the pole has a threaded interior about the end for receiving the screw-like end; and,
d) instructions for assembling the inverted T-shaped member, the second clamping member and the pole together to secure the pole to the adjacent boards.

In yet another aspect of the disclosure there is provided, a kit for securing pole, comprising:
a) an inverted T-shaped member having a base and a stem, the base forming an elongate
clamping portion sized in a first dimension to fit through a slot between two adjacent boards, the slot having a width of W wherein W<=⅓″ inch, the elongate clamping portion having a length greater than 3 W, the stem of the T-shaped member having one of a screw-like end portion or a loop at an end thereof and pin for inserting into the loop;
b) a second clamping member having a greater length and width than 3 W;
c) a pole having an end for adjustably relatively coupling to the second clamping member,
wherein the pole has an interior for releasably locking with the screw-like and portion or loop and pin of the inverted T-shaped member; and,
d) instructions for assembling the inverted T-shaped member, the second clamping member
and the pole together to secure the pole to the adjacent boards.

### BRIEF DESCRIPTION OF THE DRAWINGS

Exemplary embodiments of the disclosure will now be provided in accordance with the drawings in which:

FIG. 1 is a cross-section end view of a device in accordance with a first embodiment of the disclosure.

FIG. 2 is an exploded view of a preferred second embodiment illustrating components and order of assembly.

FIG. 3 is a view showing the second embodiment of FIG. 2 assembled.

FIG. 4 is a cross-sectional drawing of the inverted T-shaped member shown screwed into a length of the pole, wherein the lower portion of the pole is threaded for screwing into the base, not shown in the figure.

FIG. 5 is a perspective view of the clamping system having cup holder extending from the upright pole.

FIG. 6 show the second embodiment wherein the inverted T-shaped member is fixedly attached to the pole and where in the pole is screwed into the base and clamping is achieved by adjusting the distance the pole is within the base; FIG. 6 is shown in a clamped position.

FIG. 7 is a figure similar to FIG. 6, shown in an unclamped position

FIG. 8 is an exploded view of the first embodiment shown in FIG. 1.

### DETAILED DESCRIPTION.

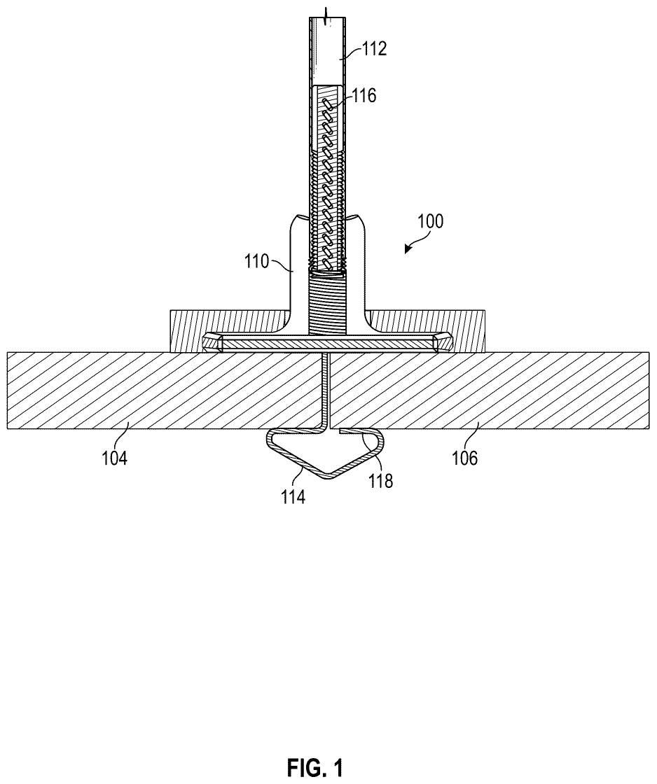

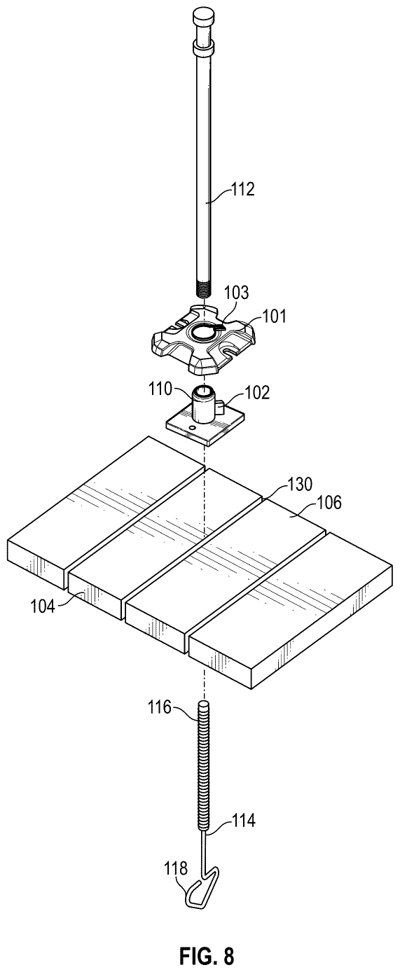

Turning now to FIG. 1 a first embodiment of a clamping device 100 is shown clamped to a deck and inserted between deck planks 104 and 106. A gap between deck planks is typically 0.125″ to about 0.25″ however gap sizes may vary and may be larger or smaller. The device 100 includes a base 110 shown resting upon planks 104 and 106. Securely screwed into the base into a fixed tightened position extending upward from the base 110 is a pole 112 having interior walls formed to accept a screw-like end of an inverted T-shaped member 114. The pole can be a two-piece pole having an upper portion and a lower detachable portion that accepts the screw-like end of the inverted T-shaped member. A top end of the inverted T-shaped member 114 is formed into a screw 116 as is shown clearly in FIG. 8 and a bottom end 118 forms the clamping end of the inverted T shaped member. The lower end the of the inverted T shown touching planks 104, 106 is referred to as a first elongate clamp portion 118. The first elongate clamp portion 118 should be a length sufficient to clamp and hold an upper structure it supports when pulled tightly against the deck when tightened. A bottom side of the base 110 forms a part of a second clamping member. FIG. 1 shows the first elongate clamp portion and the second clamping member tightly clamping the planks 104, 106. The pole 112 extending upward from the base 110 is preferably a telescoping pole. In an embodiment now shown the pole 112 and the base 110 may be a unitary structure. However, when the device 100 is packaged as a kit, it is preferable that the pole 112 be separate from the base 100.

In the exploded view of FIG. 8, the inverted T-shaped member 114 is shown having a lower segmented end clamp surface 118 and twisted helical-like screw upper end 116. Although the bottom portion of the T-shaped member does not form a conventional T as it has a gap along the lower clamping surface it is referred to hereafter as an inverted T-shaped member. The helical-like screw is formed by winding a portion of the member 114 around itself disposed in a position to be inserted into the gap 130 between planks 104 and 106. The end of member 114 could be any other type of screw that translates rotational movement into linear movement. For example, the upper end 116 of 114 may otherwise be a conventional threaded end. The bottom end of the inverted T-shaped member must be sized to be narrow enough in one dimension to fit through the slot between adjacent planks on the deck. For example, if the gap between deck boards is ¼″ the width of the inverted T-shaped member 114 should be slightly less than ¼″ so as to fit through the slot. Once the member 114 is inserted between planks 104 and 106, it is turned so that the inverted T-shaped base is orthogonal to the longitudinal gap between the planks. The operation of the clamping device will be explained later below. When the device is pre-assembled for insertion between the planks, the base 110 is placed to rest upon the planks, with the optional plastic cover kick plate 101 is placed upon the base with the pole 112 inserted with its threaded end into a complementary threaded opening of the base. The pole 112 is then securely tightened within the base end 116. The twisted screw like end of the inverted T-shaped rod 114 is then screwed into the interior of pole 112 as can be seen in FIG. 1.

The optional plastic cover kick plate 101 is shown having a notch 103 which engages a protruding nub 102 of the base 110. Thus, when the kick plate 101 is coupled with the base 110, turning the plate 101 turns base 110. Conveniently when assembling the device 100 the kick plate can be kicked with a foot to turn it, thereby turning the base 110 which in turn, turns on the pole and while lifting up on the pole 112, the clamping surfaces can be tightened against the planks, thereby fully supporting the pole 112 in a stationary upright position.

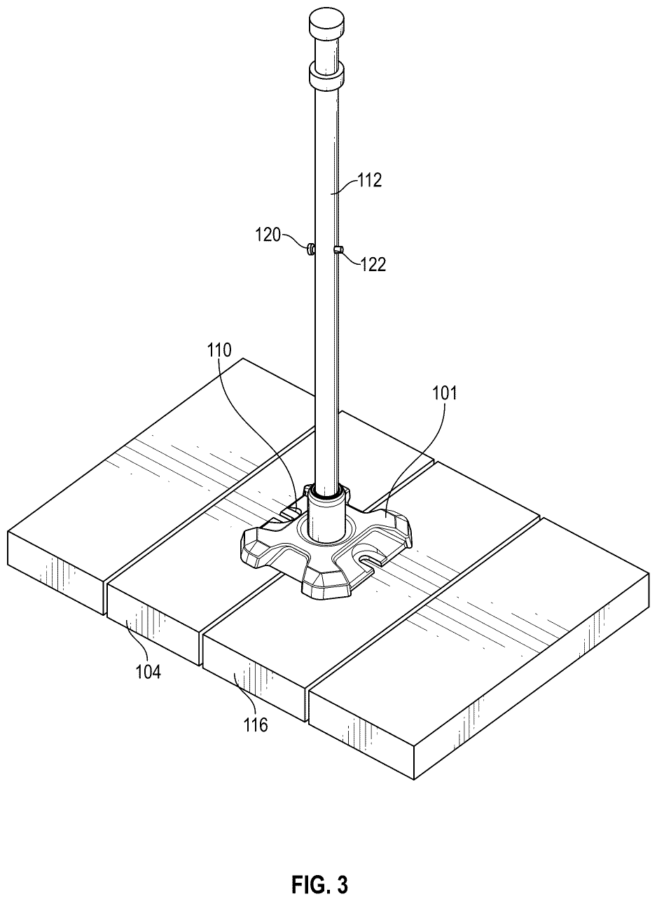

Referring to FIG. 3 the device 100 is shown with the upper end of the pole having a telescoping second pole therewithin which can be adjusted for height and tightened. The end of the telescoping pole has an extending arm, not shown, with a cup holder for receiving a cup or glass. In other embodiments a plurality of devices 100 may together form a base for a temporary railing. In other embodiments, the upper end may support an umbrella. There are a plurality of uses for having a pole extend from a deck, wherein the pole can be moved to different locations and be securely fastened.

In operation, the clamping device 100 can be described simply and used in the following manner. The pole 112 is tightly screwed into the base 110, and the screw-like end 116 of inverted T-shaped member 114 is inserted through the opening of the base 110 partially screwed into the pole 112, thereby securely hanging from the pole but not fully screwed into the pole. A sufficient length of the upper end of the inverted T-shaped member with the screw at one end should remain extended out of the pole 112 so that the bottom end 118 of the inverted T-shaped member can serve as a lower clamp face and can be aligned with and disposed into the slot between adjacent planks 104, 106; After insertion into the slot the bottom end 118 should be oriented at a non-zero angle, and preferably orthogonal to the slot on the underside of the deck. Pulling upward on the pole 112 will automatically pull up on the inverted T shaped member 114 with the bottom end 118 engaging the underside of the deck; the base 110 or the pole secured into the base is turned clockwise to clamp together the base with the bottom end 118 of the inverted T-shaped member 114. This clockwise action tightens the screw-like end of the inverted T-shaped member which clamps it and the base 110 against the planks.

The inverted T-shaped member is preferably formed of a single length of wire, and may be configured as a single inverted T absent the gap in the inverted T shown in the figures and may also be absent the loop as shown at the bottom end.

In the embodiments described heretofore in accordance with a first embodiment of this disclosure means for releasably locking the pole with the upper end of T-shaped member is embodied in the screw-like end 116 shown in FIG. 8 and a complementary receiving lower end portion of the pole adapted to receive the screw-like end 116. In this embodiment, tightening the two clamping surfaces was described by screwing the screw-like end 116 and the complementary receiving end of the pole 112 together.

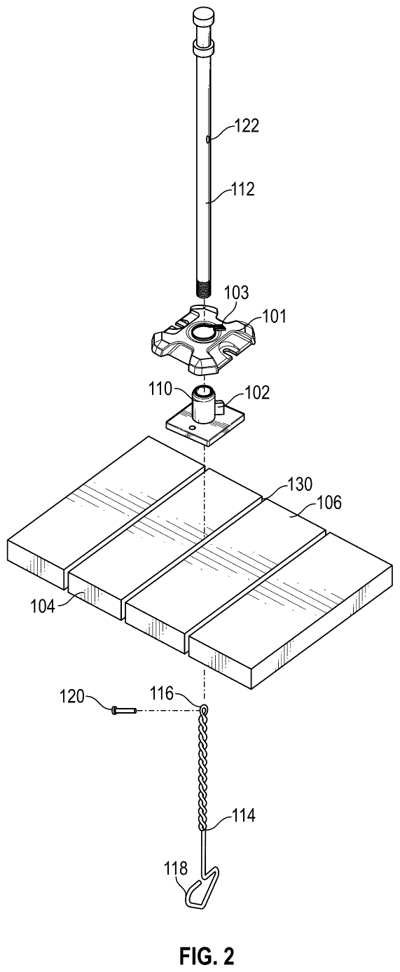

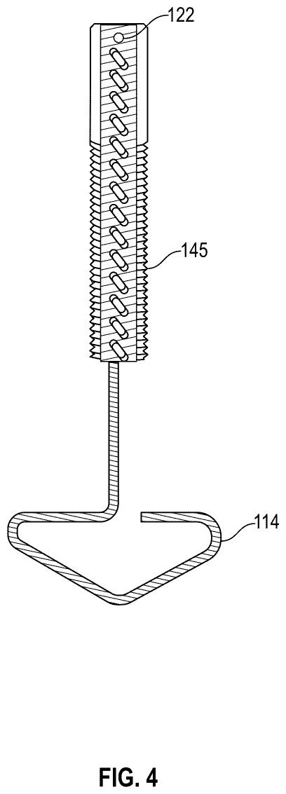

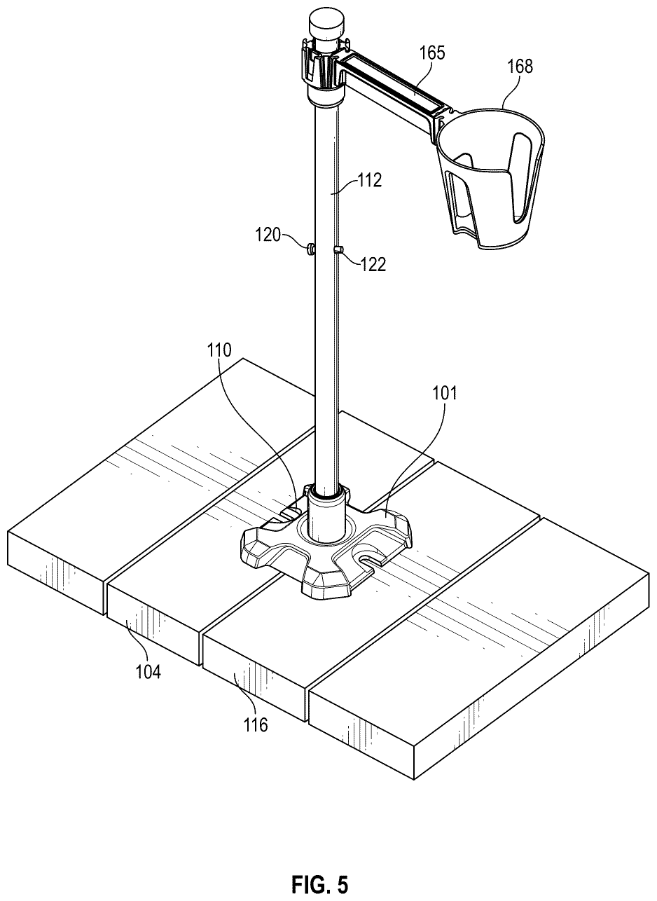

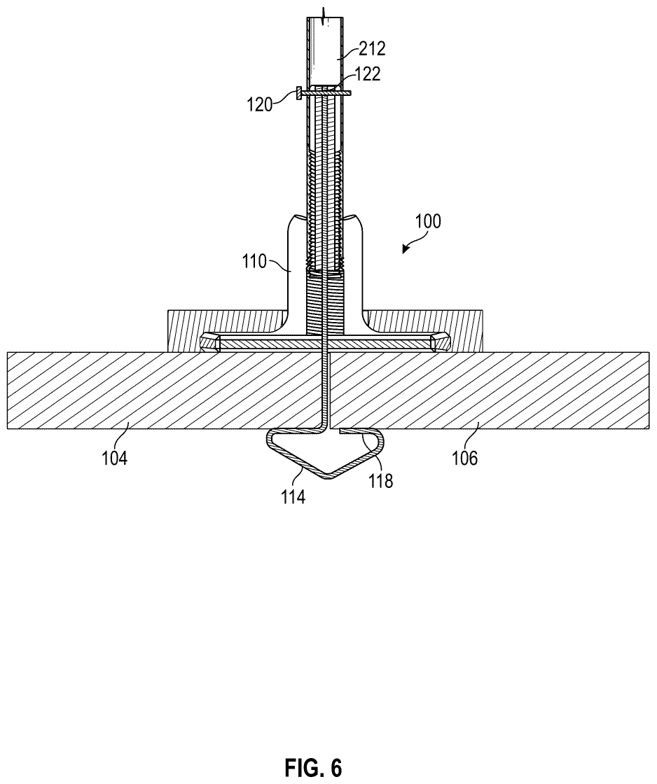

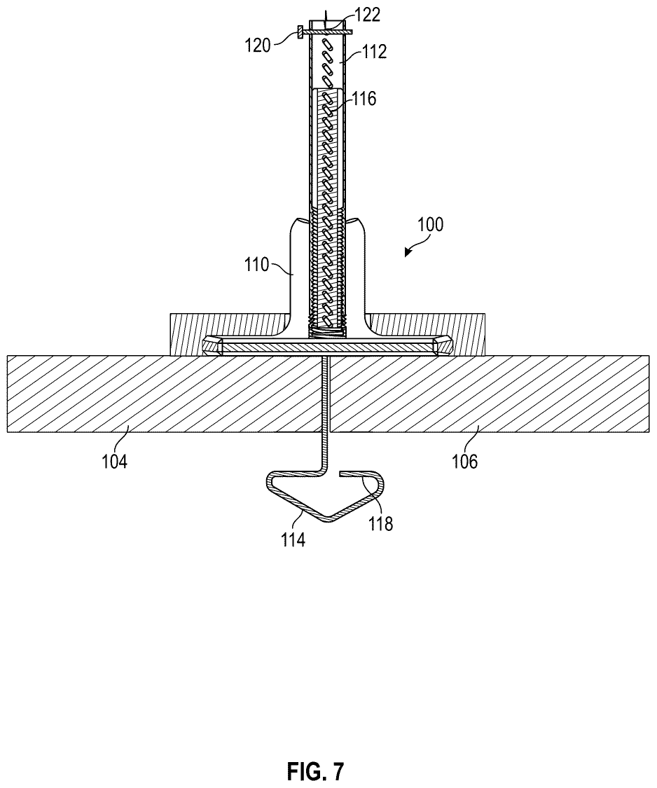

In another preferred embodiment shown in FIG. 2, FIG. 3, FIG. 4, FIG. 5, FIG. 6 and FIG. 7 where the two clamping surfaces 118 and the base of 110 are brought together and tightened against the boards 104, 106, by relatively moving the upper clamping surface 110 and the pole 112 away from each other, by loosening their respective screw like male and female threaded portions, thereby backing off their tightened position which will be described in more detail hereafter. In this embodiment the inverted T-shaped member is removably but fixedly coupled to the pole 112, so that when the pole is forced in an upward direction away from the deck, the T-shaped member moves with it. Thus, if the pole and upper clamping surface are moved away from one another and the upper clamping surface is resting on the deck the force created by physically increasing the distance of the base of the pole and the upper clamping surface results in bringing the lower clamping surface and upper clamping surface closer together thereby clamping the deck. In FIG. 2 the inverted T-shaped member is shown having a loop at 116 formed at a top end thereof. The loop is conveniently formed by folding a top section of the metal rod onto itself and twisting. This provides a secure loop at the top end of the T-shaped member capable of sustaining the force of clamping. Thus, when the upper end 116 of the member 114 is inserted into the pole 112, a pin 120 is placed in a through-hole in the pole which threads through the secure loop as it is positioned right through the through hole, thus locking together the upper end 116 with the pole 112 is achieved by using this clevis pin 120 arrangement, and conventional locking means such as a split-pin can be used to secure the pin 120 in the through hole. Relative movement between the upper clamping surface serving as a base and the pole is achieved by having the bottom end of the pole thread into the base or alternatively the base thread into the pole. This complementary threaded connection allows the lower end of the pole to be adjustable relative to the upper clamping base surface; adjusting the pole similarly adjusts the lower clamping member. Ideally the threaded connection should be of a length sufficient to account for differences in thickness of planks as it is this connection which needs provide enough length to ensure the lower end of the inverted T-shaped member can be inserted through the slot and engage the lower surface of the deck boards, and at the same time be tightened. FIGS. 6 and 7 shown the device in the clamped and unclamped position, respectively.

In another embodiment not shown, a similar clamping device can be used to clamp between fence boards, wherein the pole projects outward from a fence to secure objects, rather than be upstanding.

1. A clamping system for removably securing a pole to a plurality of boards, each board having a first surface and an opposing second surface, wherein adjacent boards have a longitudinal slot therebetween, comprising:
An inverted T-shaped member having an elongate clamping portion about a bottom end thereof, the elongate clamping portion sized in a first dimension to fit through the longitudinal slot between two adjacent boards, the longitudinal slot having a width W, the elongate clamping portion having a length L larger than the width W, said elongate clamping portion for engaging second surfaces of two adjacent boards when oriented at a non-zero angle to the longitudinal slot between the two adjacent boards, wherein the inverted T-shaped member has an upper end portion;
a second clamping member having a greater length and width than W, said second clamping member for engaging upper surfaces of the two adjacent boards; and,
a pole for releasably coupling to the second clamping member, the pole having an opening to accommodate the upper end portion of the inverted T-shaped member, wherein the pole and the upper end portion of the inverted T-shaped member include means for releasably locking together, and whereby turning one of the pole and the second clamping means relative to the inverted T-shaped member releasably couples the elongate clamping portion and the second clamping member to the two adjacent boards.

2. The clamping system as defined in claim 1 wherein the means for releasably locking together the pole and upper end portion of the inverted T-shaped member comprises a clevis pin arrangement.

3. The clamping system as defined in claim 1 wherein the inverted T-shaped member is formed of a single rod and wherein a top end of the inverted T-shaped member is twisted to form a loop for accommodating a pin, and wherein the releasable means for locking together the pole and upper end portion of the T-shaped member is formed of the pin and a complementary recess within the pole for releasably locking the pin into a fixed position, thereby locking the inverted T-shaped member to the pole.

4. The clamping system as defined in claim 3, wherein in operation, the elongate portion of the first clamping member and the second clamping means are tightened and clamped against the two adjacent boards by relatively loosening a connection between the pole and the second clamping means after the pole is coupled to the upper end of the inverted T-shaped member.

5. The clamping system of claim 4 wherein pole and the second clamping member have threaded fastening system comprising a screw and a complementary threaded hole.

6. The clamping system of claim 5, wherein the second clamping member has a cover for interlocking and coupling therewith, the cover forming a kick-plate, wherein in operation clamping of the elongate clamping portion with the second clamping means can be actuated by turning the kick-plate with a person's foot.

7. The clamping system of claim 6, wherein the pole is a telescoping pole having an arm extending from its upper end for holding, supporting or containing an object.

8. A clamping system for removably securing a pole to a deck having an upper surface and a lower surface, the deck having a longitudinal gap between adjacent deck boards, comprising:
an inverted T-shaped member having a bottom portion and a top portion;
wherein the bottom portion of the inverted T-shaped member is sized to be inserted through a longitudinal slot between adjacent deck boards,
wherein the top portion of the inverted T-shaped member includes a first portion of a releasable locking mechanism, wherein the inverted T-shaped member is of a length such that the top portion extends above the upper surface of the deck when the bottom portion is below the lower surface of the deck;
a pole having a second complementary portion of the releasable locking mechanism for releasably locking with the first portion;
an upper clamping base member for receiving and coupling with an end of the pole, wherein the coupling is relatively adjustable with the pole, wherein relative movement between the pole and upper clamping member or between the pole and the inverted T-shaped member pulls the upper clamping base member and the bottom portion of the inverted T-shaped member together against the adjacent deck boards between.

9. The system of claim 8, wherein the pole has lower end with complementary threads for receiving a screw-like end of the top portion of the inverted T-shaped member.

10. The system of claim 1, wherein the second clamping means forms a base having an upper end for receiving and tightly coupling a lower end of the pole, and wherein the base and the bottom portion of the inverted T-shaped member together clamp against the deck boards when a screw-like end of the inverted T-shaped member is tightly screwed into the complementary threads within the pole.

11. A clamping system as defined in claim 3, comprising an arm for coupling with and extending from the pole, said arm having about an end thereof a holder for holding an item, and wherein the pole is a telescoping pole.

12. A clamping system as defined in claim 10, comprising an arm for coupling with and extending from the pole, said arm having about an end thereof a holder for holding an item, and wherein the pole is a telescoping pole.

13. A kit for securing pole, comprising:
a) an inverted T-shaped member having a base and a stem, the base forming an elongate clamping portion sized in a first dimension to fit through a slot between two adjacent boards, the slot having a width of W wherein W<=⅓″ inch, the elongate clamping portion having a length greater than 3 W, the stem of the T-shaped member having one of a screw-like end portion or a loop at an end thereof and pin for inserting into the loop;
b) a second clamping member having a greater length and width than 3 W;
c) a pole having an end for adjustably relatively coupling to the second clamping member, wherein the pole has an interior for releasably locking with the screw-like and portion or loop and pin of the inverted T-shaped member; and,
d) instructions for assembling the inverted T-shaped member, the second clamping member and the pole together to secure the pole to the adjacent boards.

14. The kit of claim 13, further comprising a set of instructions for assembling parts in the kit together.
